(19) United States
(12) Patent Application Publication
(10) Pub. No.: US 2024/0368010 A1
(43) Pub. Date: Nov. 7, 2024

(54) Method and System for Water Treatment

(71) Applicant: Burnett Lime Company, Inc., Campobello, SC (US)

(72) Inventors: C. Hugh Burnett, Campobello, SC (US); Casey M. Burnett, Campobello, SC (US); Sandy A. Smith, Cleveland, GA (US); Brian M. Smith, Inman, SC (US)

(21) Appl. No.: 18/653,213

(22) Filed: May 2, 2024

Related U.S. Application Data
(60) Provisional application No. 63/500,041, filed on May 4, 2023.

(51) Int. Cl. C02F 1/66; C02F 1/44; C02F 103/00

(52) U.S. Cl. CPC C02F 1/66; C02F 1/442; C02F 1/444; C02F 2103/007; C02F 2305/14

(57) ABSTRACT

In general, the present disclosure is directed to a method of pretreating raw surface water, including dosing carbon dioxide into a volume of the raw surface water, feeding one or more coagulants into the volume of the raw surface water; and decreasing the turbidity of the raw surface water by further dissolving at least the coagulant from said feeding.

### CROSS REFERENCE TO RELATED APPLICATIONS

This application claims filing benefit of U.S. Provisional Application Ser. No. 63/500,041, having a filing date of May 4, 2023, the entire contents of which are incorporated herein by reference.

### BACKGROUND

Surface water treatment plants draw fresh water from various bodies of water, including rivers and lakes, for the purpose of chemically treating the water to a finished product for public consumption. The treatment process includes various types of chemical addition, coagulation/flocculation, sedimentation, filtration, and disinfection before passing water through a distribution system to homes and industries.

The parameters of raw water from rivers and lakes have unique physical and chemical properties that require specific treatment. For each water source, many factors may affect the treatability of the water prior to filtration. Plant operators must evaluate color levels, turbidity (water clarity), and the level of naturally dissolved organic materials, measured in Total Organic Carbon (TOC).

One of the most critical factors in pre-filtered water treatment and throughout water processing centers around pH. Various aspects of coagulation/flocculation are dependent upon determining the optimum pH for removal of turbidity, color, and TOC in the sedimentation of solids within the basins before filtration. Extreme high and low pH values in pre-filtered water will result in filter loading and loss of the plant function. Even though some coagulants can have flocculation below a pH of 5 or above a pH of 8, it is critical to identify an optimum pH for flocculation. Further, once an optimum pH for flocculation is identified, it is challenging to maintain a stable pH and coagulation through constantly changing weather conditions.

The addition of slaked lime (e.g., calcium hydroxide) raises alkalinity which effectively increases pH and adds needed hardness to the water. Unfortunately, however, the solubility of slaked lime in water is very low at about 1 part slaked lime per 1000 parts water, and the time to reach complete saturation can occur very slowly. Thus, when lime is used to adjust pH, alkalinity, and hardness to the desired levels, turbidity is frequently increased to an unacceptable value. For example, a typical requirement is that potable water from e.g., reverse osmosis treatment must have less than 1 nephelometric turbidity unity (NTU) of turbidity, or less than 0.3 NTU from membrane filtration for surface water. The addition of slaked lime in quantities sufficient to positively affect pH, alkalinity, and hardness will typically also cause an unacceptable increase in turbidity to values of about 2 NTU or higher, such at about 4 NTU or higher.

Since most coagulants reduce pre-filtered pH by increasing the coagulant dosage, the standard mode of operation is to increase or over-feed the coagulant until the optimum pH is reached for enhanced coagulation (e.g., increasing dose of coagulant to lower the pH). Flocculation can proceed with a higher coagulant dose at a lower pH, but the water's natural alkalinity is lowered along with increased treatment costs to the plant.

Accordingly, an improved method for pretreating surface water is needed that stabilizes pH of the pretreated surface water without increasing the dosage of coagulants, thus enhanced coagulation can be achieved without increasing the amount of coagulants used.

### SUMMARY

In general, the present disclosure is directed to a method of pretreating raw surface water, including dosing carbon dioxide into a volume of the raw surface water; feeding one or more coagulants into the volume of the raw surface water; and decreasing the turbidity of the raw surface water by further dissolving at least the coagulant from said feeding.

In one embodiment, said decreasing can include applying mechanical agitation by positioning at least one impeller within a flow path of the raw surface water at a location along the flow path that is after a location where feeding the one or more coagulants occurs, and rotating the at least one impeller with a speed of rotation sufficient to decrease the turbidity of the raw surface water.

In one embodiment, said decreasing can include applying a shear static mixer to the raw surface water.

In one embodiment, the raw surface water can include water drawn from a creek, lake, river, reservoir, stream, wetland, or a combination thereof.

In one embodiment, carbon dioxide may be dosed into the volume of the raw surface water via injecting the carbon dioxide into the volume of the raw surface water using an inlet flow channel.

In one embodiment, an inline gas diffuser can be utilized to inject the carbon dioxide into the volume of the raw surface water.

In one embodiment, a pressurized carrier is utilized to inject the carbon dioxide into the volume of the raw surface water.

In one embodiment, the carbon dioxide can be fed into the volume of the raw water at a dosage of from about 5 mg/L to about 100 mg/L based on the volume of the raw surface water.

In one embodiment, the pH of the raw surface water can be lowered such that it is in a range of from about 5.5 to about 7.5.

In one embodiment, said step of applying mechanical agitation can include rotating a device within the volume of the raw surface water and the carbon dioxide so as to shear the volume of the raw surface water at a rate sufficient to lower the turbidity.

In one embodiment, the coagulant can include a metal salt, an inorganic polymeric material, or a combination thereof.

In one embodiment, the metal salt can include ferrous salt, aluminum salt, copper salt, magnesium salt, or a combination thereof.

In one embodiment, the inorganic polymeric material can include polyaluminum chloride (PACL), polyferric sulfate (PFS), polyacrylamide (PAM), or a combination thereof.

In one embodiment, the coagulant can be fed into the volume of the raw surface water at a dosage of from about 0.1 mg/L to about 150 mg/L based on the volume of the raw surface water.

In another exemplary embodiment, the present disclosure is directed to a method for water treatment, including pretreating a volume of raw surface water, providing the pretreated raw surface water for filtration; and filtering the raw pretreated surface water.

In one embodiment, the pretreated water can be filtered using a conventional media filter.

In one embodiment, the pretreated raw surface water is filtered using a micro-, nano-, or ultra membrane filter.

In one embodiment, the method can include feeding a second dose of carbon dioxide, a dose of calcium hydroxide, or a combination thereof to adjust the pH of the pretreated and filtered surface water.

In one embodiment, the said feeding calcium hydroxide can include preparing a slurry from the calcium hydroxide and water; and feeding the slurry into the water or after feeding the second dose of carbon dioxide to the pretreated and filtered raw surface water.

In another exemplary embodiment, the present disclosure is directed to a system for water treatment, including a first channel providing a flow of a raw surface water; a second channel that intersects said first channel and provides a flow of CO₂ into the flow of water of said first channel; a third channel intersecting said first channel to provide a flow of one or more coagulants into the flow of water provided by first channel, said second channel intersecting downstream of the intersection of said second channel and said first channel; and an agitator positioned downstream of the intersection of said third channel and said first channel.

Each of the example aspects recited above may be combined with one or more of the other example aspects recited above in certain embodiments. For instance, all of the example aspects recited above may be combined with one another in some embodiments. As another example, any combination of two, three, four, five, or more of the twenty example aspects recited above may be combined in other embodiments. Thus, the example aspects recited above may be utilized in combination with one another in some example embodiments. Alternatively, the example aspects recited above may be individually implemented in other example embodiments. Accordingly, it will be understood that various example embodiments may be realized utilizing the example aspects recited above.

These and other features and aspects, embodiments and advantages of the present invention will become better understood with reference to the following description and appended claims.

### BRIEF DESCRIPTION OF THE DRAWINGS

A full and enabling disclosure of the present disclosure is set forth more particularly in the remainder of the specification, including reference to the accompanying figures, in which:

FIG. 1 presents a flow chart of steps according to an exemplary method disclosed herein.

FIG. 2 presents a perspective view of an exemplary embodiment of an apparatus for water treatment according to the present disclosure.

Repeat use of reference characters in the present specification and drawings is intended to represent the same or analogous features or elements of the present invention.

### DETAILED DESCRIPTION

Reference will now be made in detail to example embodiments of the disclosure. It is to be understood by one of ordinary skill in the art that the present disclosure is a description of exemplary embodiments only and is not intended as limiting the broader aspects of the present disclosure.

The present disclosure is generally directed to a method for pretreatment of raw water source to reduce the dosage of chemicals needed in the water treatment process. Herein, “pretreatment” refers to feeding carbon dioxide (CO₂) into a raw, pre-filtered water source prior to coagulation, flocculation, sedimentation, and/or filtration. Advantageously, pretreating a raw water source with CO₂, as disclosed herein, may lower and/or stabilize the pH of the raw water source prior to downstream treatment steps (e.g., coagulation, flocculation, etc.). According to the present disclosure, methods disclosed herein may stabilize pH of the water source without utilizing lime softening (e.g., CaOH₂) in the pretreatment process.

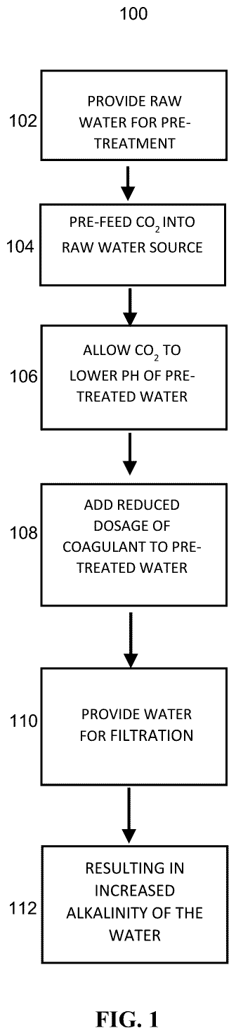

FIG. 1 depicts pretreating a raw water source with carbon dioxide. The addition of CO₂ to a raw water source may beneficially improve dissolved inorganic carbon (DIC) of the raw water source which supports corrosion control in the finished water product. Stabilizing the pH of the raw water source prior to coagulation reduces the dosage of coagulant added to the water and lowers the overall cost of the water treatment process. Reducing the dosage of coagulant added to the raw water source may lower the amount of alkalinity consumed. Further, methods disclosed herein may be utilized to improve total organic carbon (TOC) and color removal of the water source while reducing sedimentation sludge that has to be sent to landfills.

Prior to pretreating the raw water source, various physical and chemical properties may be measured that affect the treatability of the water prior to filtration. Physical and chemical properties that may be measured prior to pretreatment may include, but are not limited to, color levels, turbidity, naturally dissolved organic materials (e.g., total organic carbon (TOC)), pH, turbidity, hardness, alkalinity, etc. For instance, in one embodiment, the alkalinity of the raw water source may be measured prior to pretreatment. As used herein, “alkalinity” refers to the buffering capacity of water and to the ability of water to neutralize acids and bases, thereby maintaining a fairly settled or constant pH. In another embodiment, turbidity of the raw water source may be measured prior to pretreatment. As used herein, “turbidity” refers to the clarity of the water caused by the presence of suspended particles in said water. Turbidity may be reported in nephelometric turbidity units (NTU). Typically, an NTU of less than 0.3 is required for certain drinking water applications. In another embodiment, hardness of the raw water source may be measured prior to pretreatment. As used herein, “hardness” refers to the amount of multivalent cations (e.g., Mg²⁺, Ca²⁺, etc.) in water.

The raw water provided for treatment 102 may have various physical and chemical properties depending on the origin of the water. According to the present disclosure, the raw water may include surface water. For instance, surface water may include, but is not limited to, water drawn from a creek, lake, river, reservoir, stream, wetland, or a combination thereof. Further, the raw water may include a blend of surface water and ground water.

Regardless of the raw water source, methods disclosed herein may be utilized to adjust or stabilize various physical and chemical properties of the raw water source. According to the present disclosure, the raw water may initially undergo pretreatment of dosing carbon dioxide 104 into the raw water. In one embodiment, carbon dioxide may be dosed into a volume of the raw water via injecting carbon dioxide into the raw water using an inlet flow channel. For instance, an inline gas diffuser may be utilized to inject CO₂ bubbles into the raw water source. In another embodiment, a pressurized carrier may be utilized to inject the carbon dioxide into the volume of the raw surface water. The dosage of CO₂ may vary depending on parameters of the raw water source. For instance, the dosage of CO₂ added to the raw water source may be from about 5 mg/L to about 100 mg/L, such as from about 10 mg/L to about 80 mg/L, such as from about 20 mg/L to about 60 mg/L, such as from about 25 mg/L to about 50 mg/L, or any range therebetween based on the volume of water.

In one embodiment, CO₂ may be dosed into a volume of the raw water to stabilize pH of the water. In another embodiment, CO₂ may be dosed into a volume of the raw water to decrease the pH of the raw water. Following the addition of CO₂, the pH of the pre-treated raw water 106 may be lowered or stabilized at an optimum pH value in the range of from about 5 to about 7.5, such as from about 5.5 to about 6.5, or any range there between.

Advantageously, dosing CO₂ into the raw water source prior to coagulation and/or flocculation stabilizes the pH of the raw water source. Subsequently, various chemicals may be added to the water source for the coagulation or flocculation of undesired components to be removed by filtration. In one embodiment, a coagulant may be dosed into the water source. Pretreating the raw water source with CO₂ adds dissolved inorganic carbon (DIC) to the water source and may reduce the amount of coagulant added to the volume of the raw water 108. In one embodiment, the amount of coagulant added to the volume of the raw water may be reduced by from about 30% to about 70%, such as from about 35% to about 65%, such as from about 40% to about 55%, or any range therebetween.

In one embodiment, a coagulant can be fed into the volume of the raw surface water at a dosage of from about 0.1 mg/L to about 150 mg/L, such as from about 0.5 mg/L to about 100 mg/L, such as from about 1 mg/L to about 75 mg/L, such as from about 5 mg/L to about 50 mg/L, such as from about 10 mg/L to about 35 mg/L, or any range therebetween. The coagulant may include, but is not limited to, a metal salt, an inorganic polymeric material, or a combination thereof.

For instance, the coagulant may be a metal salt including, but not limited to, ferrous salt, aluminum salt, copper salt, magnesium salt, or a combination thereof. The metal salt may be dosed into the volume of the raw water at a concentration of from about 5 mg/L to about 150 mg/L, such as from about 10 mg/L to about 70 mg/L, such as from about 15 mg/L to about 60 mg/L, such as from about 20 mg/L to about 50 mg/L, or any range therebetween. In one embodiment, a ferrous salt may be dosed into the volume of the raw water source including, but not limited to, ferric sulfate (FeSO₄) or ferric chloride (FeCl₂). In another embodiment, an aluminum salt may be dosed into the volume of the raw water including, but not limited to, aluminum sulfate (Al₂(SO₄)₃) or aluminum chloride (AlCl₃). In another embodiment, a copper salt may be dosed into the volume of the raw water including, but not limited to, copper sulfate (CuSO₄) or copper chloride (CuCl₂).

According to the present disclosure, a coagulant dosed into the volume of the raw water may be an inorganic polymeric material. The inorganic polymeric material may be dosed into the volume of the raw water at a concentration from about 0.1 mg/L to about 5 mg/L, such as from about 0.25 mg/L to about 2.5 mg/L, such as from about 0.4 mg/L to about 2 mg/L, or any range therebetween. For instance, the inorganic polymeric material may include, but is not limited to, polyaluminum chloride (PACL), polyferric sulfate (PFS), polyacrylamide (PAM), or a combination thereof.

Pretreatment of raw water (e.g., surface water or a blend of ground and surface water) typically includes softening to reduce calcium hardness levels. Advantageously, methods disclosed herein eliminate the need to pre-feed raw ground water or surface water with lime softening as a pretreatment step. In other words, the methods disclosed herein can be free of a softening pretreatment step. Thus, methods herein may reduce the overall cost of water treatment processes with stabilized lower pH and reduce coagulant dosage.

Subsequently, the pretreated raw water may be supplied for treatment 110. The pretreated raw water source provided for treatment may have a settled pH compared to a water source not pretreated with carbon dioxide. For instance, the pH of the pretreated raw water may be stable compared to a water source not pretreated with carbon dioxide. Treatment of the water source may include filtering the water source using a conventional media bed or a type of micro, ultra, or nano membrane filter. For instance, the raw water may be filtered using a micro membrane filter. In another embodiment, the raw water may be filtered using an ultra membrane filter. Conventional media bed filters may include, but are not limited to, activated carbon, reverse osmosis, mixed media, and ultraviolet filters.

While the pH of the pretreatment raw water is stable throughout the filtration process, optionally, pH of the water supply may be adjusted post-filtration by an additional dose of CO₂. For instance, CO₂ may be dosed into a volume of the filtered water supply at a concentration of from about 5 mg/L to about 100 mg/L, such as from about 10 mg/L to about 80 mg/L, such as from about 20 mg/L to about 60 mg/L, such as from about 25 mg/L to about 50 mg/L, or any range therebetween.

Pretreatment of the raw water results in increased alkalinity of the raw water in the water distribution system 112. In one embodiment, the resulting raw water may have an optimum alkalinity in the range of from about 20 mg/L to about 65 mg/L, such as from about 35 mg/L to about 50 mg/L, or any range therebetween. Maintaining an optimal alkalinity may prevent corrosion of iron pipes in a distribution system and may control lead and copper release. If needed, a calcium hydroxide slurry may be added to the filtered raw water to increase alkalinity and hardness.

The amount of coagulant dosed into a volume of the raw water may be proportionate to the amount of carbon dioxide. For instance, the ratio of metal salt to carbon dioxide may be in the range of from about 50:1 to about 1:10, such as from about 40:1 to about 1:7, such as from about 30:1 to about 1:5, such as from about 25:1 to about 1:2, such as from about 20:1 to about 1:1, or any range therebetween.

It is understood that dosages and amounts described herein may be adjusted based on the volume of the raw water. The volume of the raw water may be from about 10,000 cubic kilometers (km³) to about 1,000,000 km³, such as from about 50,000 km³ to about 750,000 km³, such as from about 100,000 km³ to about 500,000 km³, such as about 150,000 km³ to about 250,000 km³, or any range therebetween.

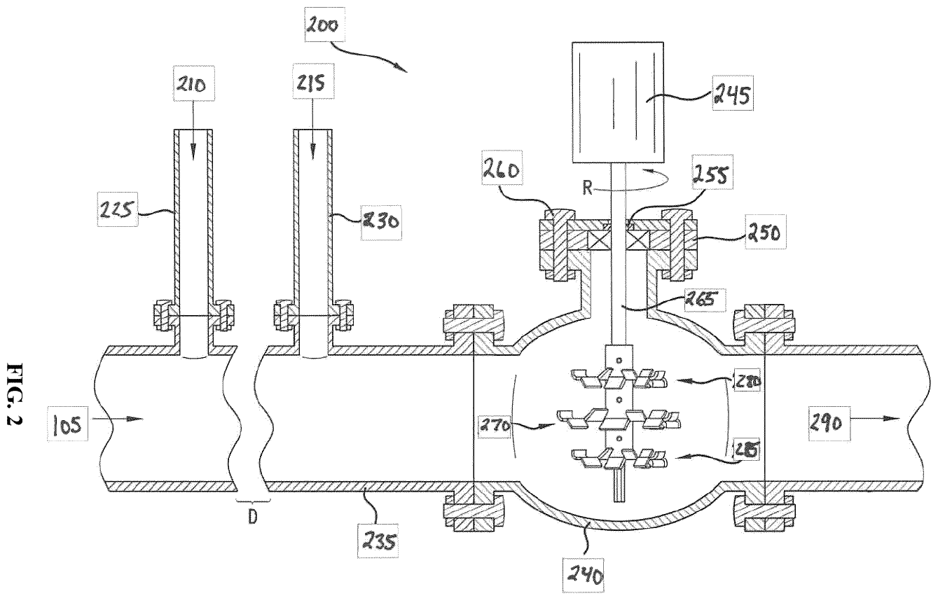

FIG. 2 shows an apparatus 200 for pretreating raw water upstream of a filtering process according to an exemplary embodiment of the present disclosure. Through a first channel 235 defined by a first channel wall, a flow of water 105 in need of pretreatment may be provided. A second channel 225 defined by a second channel wall transversely intersects first channel 235 and provides a flow 210 of CO₂ gas into water 105. A third channel 230 defined by a third channel wall also transversely intersects first channel 235 and provides a flow 215 of coagulants into the flow of water 105 in first channel 235.

Distance D represents a predetermined distance by which the intersection of third channel 230 is positioned downstream of the intersection of second channel 225 with first channel 235. Said distance D provides sufficient time for the CO₂ to lower and/or stabilize the pH of the water flow 105 before the addition of coagulations. This amount will vary with application but is typically in the range of from about 10 feet to about 80 feet. Other distances may be used, based on the apparatus, which may be shorter than 10 feet or longer than 80 feet.

Water flow 105 may continue downstream into impeller 265 within a tee 240. Impeller 265 may be used with the present disclosure as a means for providing agitation. Impeller 265 can be a shear static mixer. For instance, the impeller 265 can be an inline static mixer designed to provide equivalent shear of a mechanical mixed.

In another embodiment, impeller 265 may be a mechanical agitator. As shown in FIG. 2, impeller 265 may include disk 270, disk 280, and disk 285. Disks 270, 280, and 285 may individually include a plurality of blades. Impeller 265 is provided, for example, by INDCO of New Albany, Ind. While not intended to be bound by any particular theory, it is believed that the shear provided by the plurality of blades provide for increased shearing and/or increased collisions with particles in the water so as to assist in reducing the turbidity. Impeller 265 is provided by way of example only.

Impeller 265 is driven by a motor 245. A range of speeds for the rotation R of impeller 265 may be used. For example, a range of from about 300 rpm to about 5000 rpm may be used. Alternatively, a range of from about 1000 rpm to 2000 rpm may be used. The precise speed of rotation will depend upon a variety of factors including the design of impeller 265, the flow rate of water being agitated, the geometry of the channel or other device in which impeller 265 is placed, and other factors as well. These variables can be adjusted such that using mechanical agitation, the turbidity of the water 290 exiting device 200 can be reduced to an acceptable NTU value. For example, NTU can be reduced to a value of about 1.0 or lower.

Apparatus 200 is provided by way of example only. As will be understood by one of ordinary skill in the art using the teachings disclosed herein, other devices may be configured as well to provide water treatment according to the present disclosure. Preferably, apparatus 200 is positioned upstream of a filtering process such as e.g., a conventional or membrane filtering process. However, for some applications, apparatus 200 or other devices for water treatment according to the present disclosure may be positioned downstream of the filtering process as well.

As stated above, apparatus 200 uses mechanical agitation to provide shear mixing and lower the turbidity of the water being treated. One approach to understanding shear mixing is a measurement that relates to how much power is transferred into mechanical agitation. For example, one such measurement is referred to as the root mean velocity gradient or “G-value.” Proposed by Camp and Stein (1943), “G-value” refers to mechanical power to facilitate turbulent mixing and depends upon power, volume (i.e. the amount mixed or the container size where mixing occurs), and the viscosity of water (u). The viscosity of water is a variable factor that is dependent upon water temperature, which can vary widely from seasonal changes or the location of the water plant.

G-value can be calculated as follows:

$$G = \sqrt{\frac{P}{μ V}}$$

where:
G=velocity gradient (sec⁻¹)
P=Power or energy imparted to water (hp×550) lb-ft
μ=Dynamic viscosity of water (50° F.)
   (50° F.) 2.730×10⁻⁵ lb/ft²
   (60° F.) 2.344×10⁻⁵ lb/ft²
   (70° F.) 2.034×10⁻⁵ lb/ft²
   (80° F.) 1.791×10⁻⁵ lb/ft²
V=Liquid Volume m³ or ft³

For example, consider two colloidal particles, 0.05 ft apart, moving in a vessel. Each particle is moving at a velocity of 4 ft/sec relative to each other.

$$G = \frac{4 ft / sec}{\text{.05} ft} = \frac{80 ft / sec}{ft} = 80 \frac{1}{sec} = 80 {sec}^{- 1}$$

The greater the G-value, the faster the particles will collide. In a water treatment plant, for example, a flash mix basin can have G-values of 1000 sec⁻¹-5000 sec⁻¹, while the slower mixing flocculation basins will have G-values of 20 sec⁻¹-100 sec⁻¹.

In order to obtain the desired reduction in turbidity using apparatus 200, a G-value of about 5000 or greater is preferred although other values may be used depending upon the application and the processing time available. By way of example, using an impeller similar to impeller 265, with a 5-inch diameter blade, in a tee 240 connected to an 8-inch diameter pipe for first channel 235, a G-value of 11771.2 sec⁻¹ can be obtained with a 1 hp motor. Such configuration and G-value were applied experimentally and found to be effective at, e.g., lowering the turbidity of RO permeate to an acceptable NTU when previously treated with CO₂ as described above.

### EXAMPLES

### Example 1

Various concentrations of CO₂ were dosed into a volume of raw water to lower pH and stabilize the pH for coagulation/flocculation. The finished water pH was adjusted with calcium hydroxide slurry. The raw water prior to CO₂ dosing data points included: turbidity—24.7 NTU, temperature—12° C., hardness—130 mg/L, alkalinity—121 mg/L, pH—7.8, ferric sulfate dose—70 mg/L, lime dose 51.52 mg/L, and polymer dose—1 mg/L. To observe the quality of settled turbidity in lower basin pH, the coagulant dose and slacked lime (Ca(OH)₂) feed were decreased and the dose of CO₂ was increased in jars #2-6 (Table 1).

TABLE 1
Effects of decreasing pre-feeding of calcium hydroxide

| | Chemicals Used | | | | Analysis | | |
|---|---|---|---|---|---|---|---|
| | Ferric | | | | | | Alka- |
| Jar | Sulfate | CO₂ | Polymer | Ca(OH)₂ | Turbidity | | linity |
| # | (mg/L) | (mg/L) | (mg/L) | (mg/L) | (NTU) | pH | (mg/L) |
| 1 | 70 | 0 | 1 | 51.5 | 1.33 | 8.9 | N/A |
| 2 | 66 | 3 | 1 | 40 | 1.8 | 7.3 | N/A |
| 3 | 62 | 6 | 1 | 40 | 1.2 | 6.9 | N/A |
| 4 | 58 | 9 | 1 | 30 | N/A | N/A | N/A |
| 5 | 54 | 12 | 1 | 30 | 1.6 | 7.4 | N/A |
| 6 | 50 | 15 | 1 | 0 | 0.88 | 6.8 | 110 |
| 7 | 47 | 15 | 1 | 0 | 0.53 | 6.7 | N/A |
| 8 | 43 | 15 | 1 | 0 | 0.58 | 6.6 | N/A |
| 9 | 40 | 15 | 1 | 0 | 0.39 | 6.9 | 112 |
| 10 | 37 | 15 | 1 | 0 | 0.89 | N/A | N/A |
| 11 | 34 | 15 | 1 | 0 | 0.42 | 7.4 | N/A |
| 12 | 30 | 15 | 1 | 0 | 0.46 | 6.8 | N/A |

Surprisingly, 15 mg/L CO₂ had the best settled turbidity (Table 1). As such, jars #7-12 were held at a lower pH and CO₂ was fed at 15 mg/L to maintain a pH of 6.6. Further, the coagulant dose was decreased and no Ca(OH)₂ was fed into jars #7-12. Compared to the control, the experimental jars had improved settleability. The addition of CO₂ into the raw water source during pretreatment added dissolved inorganic carbon (DIC) along with a lower, more predictable settled pH. A lower settled pH was achieved in the raw water source while reducing ferric sulfate dose by 57%. In this example, the pre-feed dose of calcium hydroxide was observed to be counterproductive to lowering pH, and thus eliminated the need to pre-feed the raw water with calcium hydroxide.

### Example 2

Bench tests were performed to observe the effects of dosing CO₂ with calcium hydroxide slurry into a volume of raw water. The raw water data points included: turbidity—3 NTU, temperature—24° C., range of hardness—22 to 36 mg/L, alkalinity range-18 to 24 mg/L, pH range—6.7 to 7.3, and polyaluminium chloride (PACL) dose—24 mg/L.

TABLE 2
Effects of pre-feeding carbon dioxide

| | Chemicals Used | | | Analysis | | |
|---|---|---|---|---|---|---|
| | PACL | CO₂ | Ca(OH)₂ | Turbidity | | Alkalinity |
| Jar # | (mg/L) | (mg/L) | (mg/L) | (NTU) | pH | (mg/L) |
| 1 | 24 | 0 | 0 | N/A | 6.61 | 16 |
| 2 | 24 | 2 | 0 | N/A | N/A | N/A |
| 3 | 24 | 4 | 0 | N/A | N/A | N/A |
| 4 | 24 | 6 | 0 | N/A | N/A | N/A |
| 5 | 24 | 8 | 0 | N/A | N/A | N/A |
| 6 | 24 | 9 | 0 | N/A | N/A | N/A |
| 7 | 24 | 0 | 0 | 0.408 | 6.56 | 24 |
| 8 | 24 | 4 | 2 | 0.469 | 6.53 | 26 |
| 9 | 24 | 8 | 4 | 0.469 | 6.48 | N/A |
| 10 | 24 | 12 | 6 | 0.581 | 6.52 | N/A |
| 11 | 24 | 16 | 8 | 0.523 | 6.54 | N/A |
| 12 | 24 | 18 | 9 | 0.636 | 6.56 | 35 |

Increased doses of CO₂ were fed into the volume of the raw water as a pretreatment (Table 2). Further, Ca(OH)₂ was fed into the water source to progressively increase alkalinity in each jar. Compared to the control, each experimental jar had good settleability. Overall, CO₂ can be used to reduce pH when the raw water pH is high. Further, alkalinity may be stabilized using CO₂ alone or in combination with Ca(OH)₂ to maintain an optimum settled pH and basin alkalinity.

### Example 3

Bench tests were performed to observe the effects of adding CO₂ into a volume of the raw water to lower and/or stabilize the pH for coagulation/flocculation without the use of lime softening (Ca(OH)₂). To do so, each jar was pretreated with varying doses of ferric sulfate, lime, polymer, CO₂, or a combination thereof.

TABLE 3
Effects of eliminating the use of lime softening

| | Chemicals Used | | | | Analysis | | |
|---|---|---|---|---|---|---|---|
| | Ferric | | | | | | Alka- |
| Jar | Sulfate | CO₂ | PACL | Ca(OH)₂ | Turbidity | | linity |
| # | (mg/L) | (mg/L) | (mg/L) | (mg/L) | (NTU) | pH | (mg/L) |
| 1 | 18 | 0 | 0.8 | 100 | 1.49 | 10.4 | N/A |
| 2 | 18 | 20 | 0.8 | 0 | 5.64 | N/A | N/A |
| 3 | 16 | 20 | 0.8 | 0 | 5.74 | N/A | N/A |
| 4 | 14 | 20 | 0.8 | 0 | N/A | N/A | N/A |
| 5 | 12 | 20 | 0.8 | 0 | N/A | N/A | N/A |
| 6 | 10 | 20 | 0.8 | 0 | N/A | N/A | N/A |
| 19 | 32 | 30 | 0.4 | 0 | 2.1 | 6.73 | N/A |
| 20 | 34 | 30 | 0.4 | 0 | 1.3 | 6.82 | N/A |
| 21 | 36 | 30 | 0.4 | 0 | 1.19 | 6.74 | N/A |
| 22 | 38 | 30 | 0.4 | 0 | 0.64 | 6.72 | 117 |
| 23 | 40 | 30 | 0.4 | 0 | 0.87 | 6.72 | N/A |
| 24 | 42 | 30 | 0.4 | 0 | 0.93 | 6.72 | N/A |

Jars #2-6 and 19-24 had zero feed of Ca(OH)₂. Increasing the dose of CO₂ from 20 mg/L to 30 mg/L in jars #19-24 lowered and stabilized the pH at ˜6.72 (Table 3). The addition of CO₂ into the raw water source adds DIC along with a lower, more predictable settled pH. Establishing an optimum pH for enhanced coagulation/flocculation is beneficial for the settled treatment process and for corrosion control in distribution.

### Example 4

Bench tests were performed to observe the effects of pretreating a volume of raw water with CO₂ in combination with aluminum sulfate to lower and/or stabilize the pH for coagulation/flocculation. To do so, each jar was pretreated with varying doses of CO₂, aluminum sulfate, lime, or a combination thereof. The raw water data points included: turbidity—3 NTU, temperature—28° C., hardness—16 mg/L, alkalinity—16 mg/L, pH—7.4, TOC—<2 ppm, and coagulation pH—6.5-6.6.

TABLE 4
Effects of post-feeding calcium hydroxide into filtered water

| | | | | | Analysis | | |
|---|---|---|---|---|---|---|---|
| | Chemicals Used | | | | | | Alka- |
| Jar | Alum | CO₂ | NaOH | Ca(OH)₂ | Turbidity | | linity |
| # | (mg/L) | (mg/L) | (mg/L) | (mg/L) | (NTU) | pH | (mg/L) |
| 1 | 20 | 0 | 0 | 0 | 0.229 | 6.78 | 14 |
| 2 | 20 | 4 | 0 | 3 | 0.546 | 6.57 | 16 |
| 3 | 20 | 4 | 0 | 6 | 0.704 | 6.67 | 19 |
| 4 | 20 | 8 | 0 | 9 | 0.79 | 6.74 | 20 |
| 5 | 20 | 8 | 0 | 12 | 0.256 | 6.88 | 25 |
| 6 | 20 | 8 | 0 | 15 | 0.274 | 7.01 | 27 |
| 7 | 18 | 9 | 0 | 0 | 0.324 | 6.21 | 13-16 |
| 8 | 16 | 9 | 0 | 0 | 0.512 | 6.28 | 13-16 |
| 9 | 14 | 9 | 0 | 0 | 0.301 | 6.21 | 13-16 |
| 10 | 12 | 9 | 0 | 0 | 0.442 | 6.28 | 13-16 |
| 11 | 11 | 9 | 0 | 0 | 0.327 | 6.33 | 13-16 |
| 12 | 10 | 9 | 0 | 0 | 0.226 | 6.35 | 13-16 |

Jars #2-6 were pretreated with 20 mg/L aluminum sulfate and increasing doses of CO₂ and Ca(OH)₂. The pH of these jars remained relatively stable with optimum turbidity levels (Table 4). Jars #7-12 were pretreated with 9 mg/L CO₂ and decreasing doses of aluminum sulfates. Notably, these jars were not dosed with any Ca(OH)₂. Feeding jars with a constant dose of CO₂ resulted in a lower settled pH (Table 4). Further, outstanding settleability was observed in the experimental jars, even in the absence of Ca(OH)₂. Also, the lowest turbidity was observed in jar #12 which included 50% less coagulant than the control. Taken together, pre-treating raw water sources with CO₂ achieves a lower settled pH, reduces the amount of coagulant dosed into raw water sources, and eliminates using Ca(OH)₂ in pre-treatment processes of raw water sources. If desired, with a lower settled pH, the post-filter pH dosage may be increased using Ca(OH)₂ to attain desired water parameters to improve corrosion control. For instance, Ca(OH)₂ may be post-fed into a water source to reach a targeted finished alkalinity of 35 mg/L to 40 mg/L.

### Example 5

Bench tests were performed to observe the effects of pretreating a volume of a blend of raw creek and lake water with CO₂ in combination with aluminum sulfate to lower and/or stabilize the pH for coagulation/flocculation. To do so, each jar was pretreated with varying doses of CO₂, aluminum sulfate, or a combination thereof. The raw water data points included: turbidity—8.93 NTU, temperature—25° C., and pH—6.6.

TABLE 5
Using CO₂ to stabilize pH in a blend of creek and lake water

| | CHEMICALS USED | | | | |
|---|---|---|---|---|---|
| JAR | Alum | Ca(OH)₂ | CO₂ | OBSERVATIONS | |
| # | (mg/L) | (mg/L) | (mg/L) | Evaluation | pH |
| 1 | 31 | 6.7 | 0 | Large Floc, Fasting Settling | 6.58 |
| 2 | 27 | 0 | 8 | Large Floc, Fasting Settling | 6.26 |
| 3 | 23 | 0 | 8 | Large Floc, Fasting Settling | 6.13 |
| 4 | 19 | 0 | 8 | More preferred Floc | 6.16 |
| 5 | 15 | 0 | 8 | Poor | 6.2 |
| 6 | 11 | 0 | 8 | Poor | 6.18 |
| 7 | 19 | 0 | 8 | Good Floc | 6.17 |
| 8 | 18 | 0 | 8 | Good Floc | 6.05 |
| 9 | 17 | 0 | 8 | Good Floc | 6.03 |
| 10 | 19 | 0 | 12 | Suspended Floc #2 Best | 5.88 |
| 11 | 18 | 0 | 12 | Good Floc | 5.86 |
| 12 | 17 | 0 | 12 | Suspended Floc #1 Best | 5.91 |
| 13 | 17 | 0 | 12 | Suspended Floc #1 Best | 6.23 |
| 14 | 16 | 0 | 12 | Suspended Floc #1 Best | 6.15 |
| 15 | 15 | 0 | 12 | Poor | 6.15 |
| 16 | 14 | 0 | 12 | Poor | 6.17 |
| 17 | 13 | 0 | 12 | Poor | 6.09 |
| 18 | 12 | 0 | 12 | Suspended Floc #2 Best | 6.11 |

Dosing between 8 mg/L-12 mg/L CO₂ resulted in stable pH of the blended raw water and reduced the aluminum sulfate dose by 45% (Table 5). Reducing the amount of coagulant added to the water will reduce chemical cost and result in less solids to be pressed and landfilled. Further, CO₂ adds DIC to the water for improved bicarbonate alkalinity formation in post treatment. Altogether, pre-feeding the blended water with CO₂ can stabilize a lower pH and give plant operators an opportunity to establish an optimum pH that could be maintained consistently.

### Example 6

Following bench testing, a full-scale trial was conducted at a water treatment facility. CO₂ was introduced into a volume of the raw water inlet. The goal of the full-scale trial was to reduce the over feeding of chemicals, maintain quality coagulation, and add buffering to the plant's finished effluent water being pumped to various distribution systems. Previously, said distribution systems had experienced escalating pH values of water in various locations.

By adding CO₂ to the raw water intake, the alum dose was reduced by 45%, as correlated directly to a lower pH provided by the pre-feed CO₂. At certain times throughout the year, the raw pH can increase from 7 to as high as 9. In order to move the treatment pH to enhance coagulation levels in the mid-6 range, the only option is to increase the aluminum dose. Pre-feed CO₂ can constantly stabilize the pH of the raw water to avoid alum over-feed needed to optimize coagulation. Besides preparing the raw water for coagulation, CO₂ addition contributes to the formation of bicarbonate alkalinity when paired with calcium hydroxide.

After coagulation, sedimentation, and filtration, calcium hydroxide slurry was dosed using Burnett's CAL˜FLOR lime slurry in the post-filtration rapid mix to raise the finished water pH to 7.2 for distribution. Along with setting the finished pH, the combination of CO₂ and calcium hydroxide increased the finished alkalinity by as much as 30% in some distant points of the member systems. Following the month-long full-scale trial, trends of improved alkalinity and pH stability were observed (Table 6). During the trial, distribution alkalinity increased at each sampling point, and a slight favorable drop in pH at each point was observed, pointing to added buffering capacity of the water source.

TABLE 6
County #1 Creek Water Distribution System

| Loca- | pH | pH | | Alkalinity | Alkalinity | % Change in |
|---|---|---|---|---|---|---|
| tion | Day 1 | Day 36 | Δ pH | Day 1 | Day 36 | Alkalinity |
| 1 | 9.2 | 8.67 | 0.53 | 23 | 28 | 18% |
| 2 | 8.9 | 8.14 | 0.50 | 20 | 24 | 17% |
| 3 | 8.6 | 7.90 | 0.70 | 17 | 22 | 23% |
| 4 | 7.8 | 7.81 | 0.00 | 17 | 24 | 29% |
| 5 | 7.8 | 7.73 | 0.00 | 17 | 22 | 23% |
| 6 | 8.3 | 7.64 | 0.60 | 18 | 22 | 18% |

TABLE 7
County #2 Creek Water Distribution System

| Loca- | pH | pH | | Alkalinity | Alkalinity | % Change in |
|---|---|---|---|---|---|---|
| tion | Day 1 | Day 38 | Δ pH | Day 1 | Day 38 | Alkalinity |
| 1 | 7.68 | 7.26 | 0.42 | 18 | 26 | 30% |
| 2 | 8.67 | 8.30 | 0.37 | 17 | 24 | 29% |
| 3 | 7.57 | 7.48 | 0.09 | 18 | 25 | 28% |

The preceding description is exemplary in nature and is not intended to limit the scope, applicability or configuration of the disclosure in any way. Various changes to the described embodiments may be made in the function and arrangement of the elements described herein without departing from the scope of the disclosure.

Unless defined otherwise, all technical and scientific terms used herein have the same meaning as commonly understood by one of ordinary skill in the art to which this invention is related.

As used in this application and in the claims, the singular forms “a”, “an”, and “the” include the plural forms unless the context clearly dictates otherwise. Additionally, the term “includes” means “comprises”. The methods and compositions of the present disclosure, including components thereof, can comprise, consist of, or consist essentially of the essential elements and limitations of the embodiments described herein, as well as any additional or optional ingredients, components or limitations described herein or otherwise useful in biocidal compositions.

Unless otherwise indicated, all numbers expressing quantities of ingredients, properties such as molecular weight, percentages, and so forth, as used in the specification or claims are to be understood as being modified by the term “about”. Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

As used herein, “optional” or “optionally” means that the subsequently described material, event or circumstance may or may not be present or occur, and that the description includes instances where the material, event or circumstance is present or occurs and instances in which it does not. As used herein, “w/w %” and “wt %” mean by weight as relative to another component or a percentage of the total weight in the composition.

The term “about” is intended to mean approximately, in the region of, roughly, or around. When the term “about” is used in conjunction with a numerical range, it modifies that range by extending the boundaries above and below the numerical values set forth. Unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

As used herein, the terms “first”, “second”, and “third” may be used interchangeably to distinguish one component from another and are not intended to signify location or importance of the individual components.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Furthermore, certain aspects of the present disclosure may be better understood according to the examples herein, which are intended to be non-limiting and exemplary in nature. Moreover, it will be understood that the compositions described in the examples may be substantially free of any substance not expressly described.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A method of pretreating raw surface water, comprising:
dosing carbon dioxide into a volume of the raw surface water, wherein at least part of the carbon dioxide lowers the pH of the raw surface water;
feeding one or more coagulants into the volume of the raw surface water; and
decreasing turbidity of the raw surface water by further dissolving at least the coagulant from said feeding.

2. The method of claim 1, wherein the raw surface water comprises water drawn from a creek, lake, river, reservoir, stream, wetland, or a combination thereof.

3. The method of claim 1, wherein the carbon dioxide is dosed into volume of the raw surface water via injecting the carbon dioxide into the volume of the raw surface water using an inlet flow channel.

4. The method of claim 3, wherein an inline gas diffuser is utilized to inject the carbon dioxide into the volume of the raw surface water.

5. The method of claim 3, wherein a pressurized carrier is utilized to inject the carbon dioxide into the volume of the raw surface water.

6. The method of claim 1, wherein the carbon dioxide is fed into the volume of the raw surface water at a dosage of from about 5 mg/L to about 100 mg/L based on the volume of the raw surface water.

7. The method of claim 1, wherein the pH of the raw surface water is lowered to a level ranging from about 5.5 to about 7.5.

8. The method of claim 1, wherein the coagulant comprises a metal salt, an inorganic polymeric material, or a combination thereof.

9. The method of claim 8, wherein the metal salt comprises ferrous salt, aluminum salt, copper salt, magnesium salt, or a combination thereof.

10. The method of claim 8, wherein the inorganic polymeric material comprises polyaluminum chloride (PACL), polyferric sulfate (PFS), polyacrylamide (PAM), or a combination thereof.

11. The method of claim 1, wherein the coagulant is fed into the volume of the raw surface water sat a dosage of from about 0.1 mg/L to about 150 mg/L based on the volume of the raw surface water.

12. The method of claim 1, wherein the ratio of the coagulant to carbon dioxide ranges from about 50:1 to about 1:10.

13. The method of claim 1, wherein the ratio of the coagulant to carbon dioxide ranges from about 30:1 to about 1:5.

14. The method of claim 1, wherein the ratio of the coagulant to carbon dioxide ranges from about 20:1 to about 1:1.

15. The method of claim 1, wherein the decreasing step further comprises applying mechanical agitation by positioning at least one impeller within a flow path of the raw surface water at a location along the flow path that is after a location where feeding the one or more coagulants occurs, and rotating the at least one impeller with a speed of rotation sufficient to decrease the turbidity of the raw surface water.

16. The method of claim 15, wherein said step of applying mechanical agitation comprises rotating a device within the volume of the raw surface water and the carbon dioxide so as to shear the volume of the raw surface water at a rate sufficient to lower the turbidity.

17. The method of claim 1, wherein the decreasing step further comprises applying a shear static mixer to the raw surface water.

18. A method for water treatment, comprising:
pretreating a volume of raw surface water, comprising:
dosing a first dose of carbon dioxide into the volume of raw surface water, wherein at least part of the carbon dioxide lowers the pH of the raw surface water;
feeding a coagulant into the volume of the raw surface water; and
decreasing the turbidity of the volume of the raw surface water by further dissolving at least the coagulant from said feeding;
providing the pretreated raw surface water for filtration; and
filtering the pretreated raw surface water.

19. The method of claim 18, further comprising feeding a second dose of carbon dioxide, a dose of calcium hydroxide, or a combination thereof to adjust the pH of the pretreated and filtered surface water.

20. The method of claim 19, wherein the said feeding the second dose comprises:
preparing a slurry from the calcium hydroxide and water; and
feeding the slurry into the water after feeding the second dose of carbon dioxide to the pretreated and filtered raw surface water.

21. The method of claim 18, wherein the ratio of the coagulant to carbon dioxide is in the range of from about 50:1 to about 1:10.

22. The method of claim 18, wherein the ratio of the coagulant to carbon dioxide is in the range of from about 20:1 to about 1:1.

23. The method of claim 18, wherein the pretreated raw surface water is filtered using a conventional media filter.

24. The method of claim 18, wherein the pretreated raw surface water is filtered using a micro-, nano-, or ultra membrane filter.

25. A system for water treatment, comprising:
a first channel providing a flow of water from a raw surface water;
a second channel that intersects said first channel and provides a flow of carbon dioxide into the flow of the raw water of said first channel;
a third channel intersecting said first channel to provide a flow of one or more coagulants into the flow of the raw water provided by first channel, said second channel intersecting downstream of the intersection of said second channel and said first channel; and
an agitator positioned downstream of the intersection of said third channel and said first channel.
